(19) United States
(12) Patent Application Publication
(10) Pub. No.: US 2022/0151165 A1
(43) Pub. Date: May 19, 2022

(54) SYSTEM AND METHOD FOR GROWING TRELLISED PLANTS

(71) Applicant: BIOMIMECHANICAL SYSTEMS LTD., Haifa (IL)

(72) Inventor: Eliezer Israel Shraga EDELSTEIN, Haifa (IL)

(73) Assignee: BIOMIMECHANICAL SYSTEMS LTD., Haifa (IL)

(21) Appl. No.: 17/435,722

(22) PCT Filed: Mar. 3, 2020
(86) PCT No.: PCT/IL2020/050236

§ 371 Date: Sep. 2, 2021

Related U.S. Application Data
(60) Provisional application No. 62/813,296, filed on Mar. 4, 2019.

(51) Int. Cl. A01G 17/06; A01G 9/24; A01G 9/14

(52) U.S. Cl. CPC A01G 17/06; A01G 17/026; A01G 9/1476; A01G 9/247

(57) ABSTRACT

A system and a method for growing trellised plants are disclosed. The method may include growing the trellised plants downwards on rotatable tubes, letting gravity replace trellising and leaning and lowering of the plants may be replaced by wrapping their stems on the rotatable tubes, by rotating the tubes. The system may include: one or more cultivation systems; a plurality of angularly driving belts, for supporting and driving the one or more cultivation systems; and a rotatable shaft configured to rotate and carry the one or more cultivation systems hanging from the rotatable shaft by the driving belts. Each cultivation system may include a cultivation tube having a plurality of holes for planting the trellised plants; and an irrigation system for providing irrigation to the trellised plants.

### FIELD OF THE INVENTION

The present invention relates to growing trellised plants. More particularly, the present invention relates to systems and methods for growing trellised plants.

### BACKGROUND OF THE INVENTION

Trellised plants, such as, tomatoes, cucumbers, peppers and the like, are grown vertically upwards in greenhouses. Trellised plants are known to have stems which are not strong enough to hold the plants growing upwards. Therefore, the plants are tied to vertical wires. The plants can reach a length of 10 meter and more, accordingly, after few cycles of fruit picking, the plants are lowered, and the stems are leaned. This process of trellising, leaning and lowering is done repeatedly during the cultivation process of the plants and requires a lot of labor.

Accordingly, eliminating the need in trellising, leaning and lowering saves labor will increase the efficiency of growing trellised plants.

### SUMMARY OF THE INVENTION

In the present innovation the plants grow downward from rotatable tubes. Trellising may be done by gravity (without the need of wires and tying the plants) and leaning and lowering may be done by wrapping naked plants stems around the cultivation tubes by rotating the tubes. Some aspects of the invention may be directed to a system for growing trellised plants, comprising: one or more cultivation systems; a plurality of angularly driving belts, for supporting and driving the one or more cultivation systems; and a rotatable shaft configured to rotate and carry the one or more cultivation systems hanging from the rotatable shaft by the driving belts. In some embodiments, each cultivation system may include a cultivation tube having a plurality of holes for planting the trellised plants; and an irrigation system for providing irrigation to the trellised plants.

In some embodiments, the rotatable shaft is configured to be connected to a construction of a greenhouse. In some embodiments, each cultivation system further comprises a fertilizing system. In some embodiments, each cultivation tube is configured to contain a growth substrate. In some embodiments, the system may further include a power drive system configured to rotate the rotatable shaft.

In some embodiments, the system may further include a controller configured to control the power drive system. In some embodiments, the controller is further configured to control the irrigation system. In some embodiments, the controller may further controller configured to control the fertilizing system. In some embodiments, the system may further include one or more sensors and the controller may further be configured to control at least one of: the power drive system, the irrigation system and the fertilizing system according to signals received from the one or more sensors.

In some embodiments, the system may further include a braking system configured to prevent the cultivation tubes from rotating. In some embodiments, the system may further include a gutter for collecting excess water.

Some additional aspects of the invention may be related to a method of growing trellised plants. In some embodiments the method may include: planting trellised plants in one or more cultivation systems, hanged from a rotatable shaft by a plurality of upper driving belts. In some embodiments, each cultivation system may include: a cultivation tube having a plurality of holes for planting the trellised plants; and an irrigation system for providing irrigation to the trellised plants. In some embodiments, the method may include letting the trellised plants to grow downwards from at least one cultivation tube and rotating the rotatable shaft to rotate the cultivation tube after one or more fruit pickings.

In some embodiments, rotating the rotatable shaft may include wrapping naked plants stems around the cultivation tubes. In some embodiments, rotating the rotatable shaft may include removing leaves from the stems.

Some additional aspects of the invention may be directed to a system for growing trellised plants, comprising: one or more cultivation systems, one or more actuators configured to deliver a rotational movement to the one or more cultivation systems and a braking system configured to prevent the cultivation tubes from rotating. In some embodiments, each cultivation system may include a cultivation tube having a plurality of holes for planting the trellised plants and an irrigation system for providing irrigation to the trellised plants.

In some embodiments, the system may further include a power drive system configured to rotate the one or more cultivation systems. In some embodiments, the system may further include one or more elements connectable to a construction of a greenhouse. In some embodiments, each cultivation system further comprises a fertilizing system. In some embodiments, each cultivation system is configured to contain a growth substrate.

In some embodiments, the system may further include a controller configured to control the one or more power drive systems. In some embodiments, the controller may further be configured to control the irrigation system. In some embodiments, the controller may control the fertilizing system. In some embodiments, the system may further include one or more sensors and the controller may further be configured to control at least one of: the one or more power drive systems, the irrigation system and the fertilizing system according to signals received from the one or more sensors.

In some embodiments, the system may further include a gutter for collecting excess water.

Some additional aspects of the invention may be directed to method of growing trellised plants. In some embodiments, the method may include planting trellised plants in one or more cultivation systems rotatable by one or more actuators; letting the trellised plants to grow downwards from each cultivation tube; preventing the one or more cultivation systems from rotating during one or more growing circle, using a braking system connected to the one or more cultivation systems, and rotating the cultivation systems after one or more fruit pickings. In some embodiments, each cultivation system comprises a cultivation tube having a plurality of holes for planting the trellised plants and an irrigation system for providing irrigation to the trellised plants.

In some embodiments, rotating the rotatable shaft may include wrapping naked plants stems around the cultivation tubes. In some embodiments, rotating the rotatable shaft may include removing leaves from the stems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows an illustration of a system for growing trellised plants according to some embodiments of the invention;

FIG. 2 shows a more detailed illustration of the systems planted with trellised plants according to some embodiments of the invention;

FIG. 3 shows an illustration of a cultivation system according to some embodiments of the invention;

FIGS. 4A-4F show various details of the system according to some embodiments of the invention;

FIG. 5 shows an illustration of a system for growing trellised plants according to some embodiments of the invention;

FIG. 6 shows a more detailed illustration of system for growing trellised plants, planted with trellised plants according to some embodiments of the invention;

FIG. 7 is a detailed illustration of the system of FIG. 6 according to some embodiments of the invention;

FIG. 8 is a schematic illustration of the leaves removal according to some embodiments of the invention; and

FIG. 9 is a flowchart of a method of growing trellised plants according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

In the present innovation the plants grow downward from rotatable tubes. Trellising may be done by gravity (without the need of wires and tying the plants) and leaning and lowering may be done by wrapping naked plants stems around the cultivation tubes by rotating the tubes. Some aspects of the invention may be related to a system and a method for growing trellised plants downward from cultivation systems. A system and method according to embodiments of the invention may include a rotating mechanism (e.g., an actuator, belt, gear, etc.) for rotating each cultivation system. Such a mechanism may allow an automatic leaning and lowering replacement process by wrapping the stems of the plant every few cycles of fruit picking. This process may replace the manual trellising, leaning and lowering process conducted today.

The system may include cultivation tubes that may be assembled high above in a greenhouse, for example, connected to the greenhouses construction or to a standalone construction located in the greenhouses.

Furthermore, a system according embodiments of the invention may include a braking system configured to secure the rotatable cultivation systems in their position during the growth of the plants.

As used herein the term “trellised plants” refer to any plant that grows long stems which are not strong enough to hold the plants growing upwards. These plants are either spread on the earth or vertically grown by being tied to wires (or similar elements). Those plants can reach a length longer than the height of the greenhouses so the plants are being lowered and their stems are being leaned. Some examples for trellised plants are: tomatoes, cucumbers, peppers, and the like.

As used herein the term “fruit picking” may refer to picking ripe fruits from the plant. As known in trellised plants, each plant can have fruits in various stages of ripping. Only ripped for picking fruit is being picked. The ripped for picking fruits are mainly at the part of the stem closer to the roots, the more mature part of the plant.

As used herein the term “growth cycle” may refer to any one of: the time between the planting the plant and the first fruit picking and the time between each two fruit pickings until the plant is uprooted.

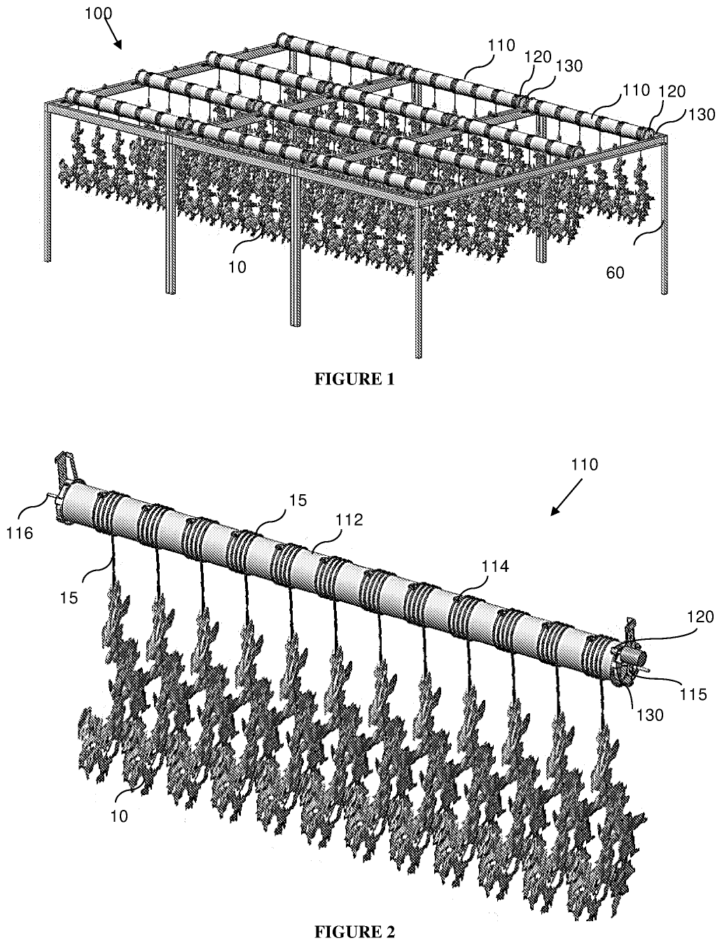

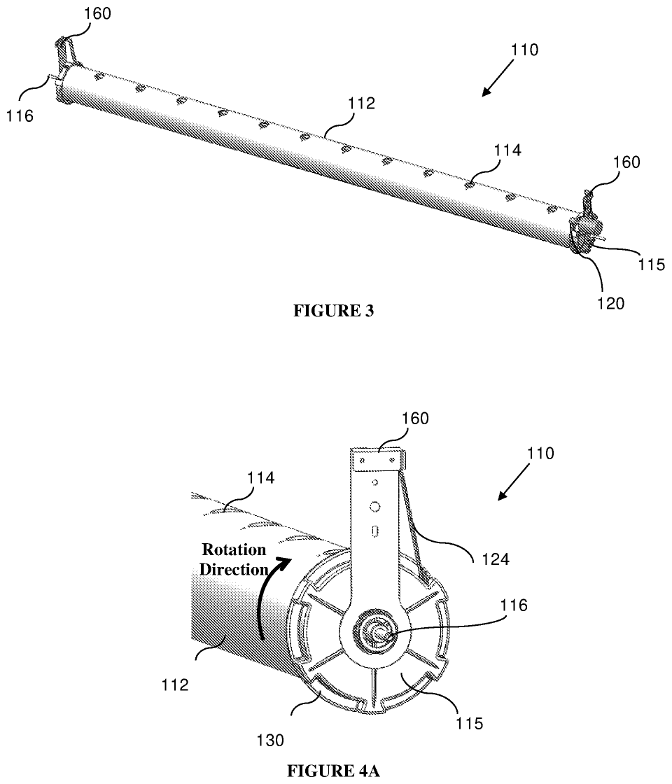

Reference is made to FIG. 1, which shows a system 100 for growing trellised plants according to some embodiments of the invention. System 100 may include one or more cultivation systems 110, one or more actuators 120 configured to deliver a rotational movement to one or more cultivation systems 110 and one or more braking systems 130 configured to prevent cultivation tubes 112 (illustrated in FIGS. 2 and 3) of cultivation systems 110 from rotating. In some embodiments, system 100 may be connected to a construction 60 which may be the construction of a greenhouse or a standalone construction located in the greenhouse. Cultivation systems 110 may be configured to be installed substantially horizontally (or with a small (0.5-3°) angle to horizontality to let water drain). Trellised plants 10 grown downwards from cultivation systems 110, as illustrated and discussed with respect to FIG. 2.

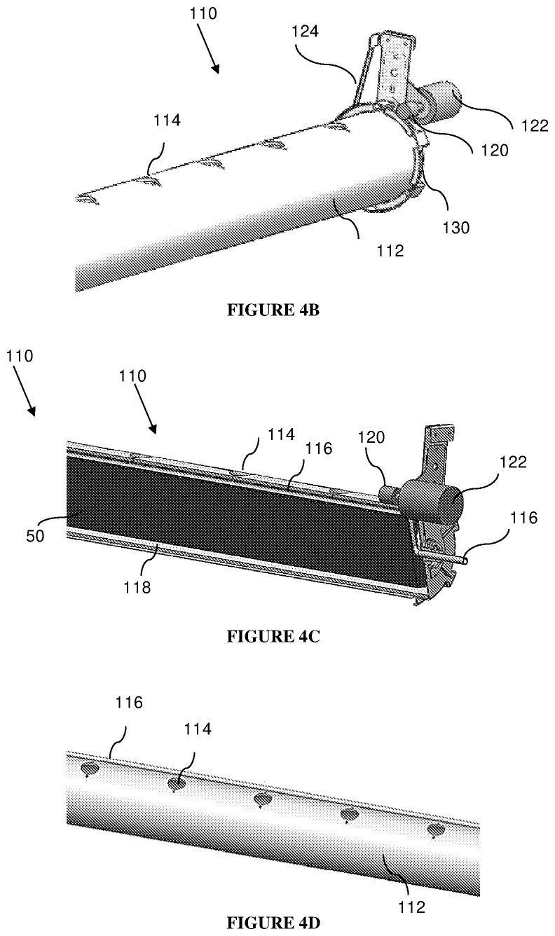

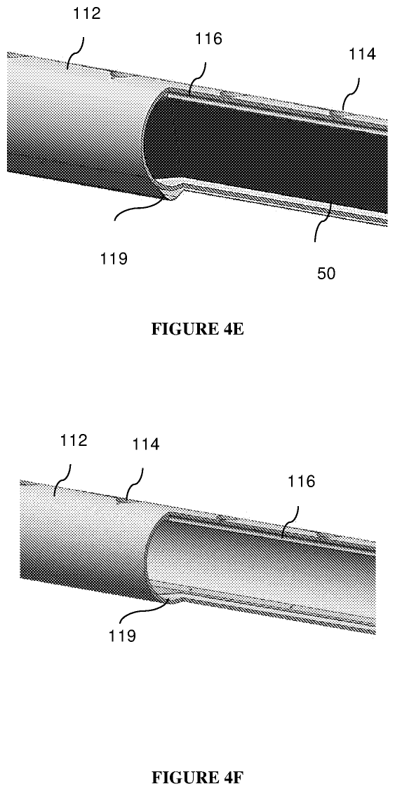

Reference is now made to FIG. 2 which is an illustration of cultivation system 110, included in system 100, planted with trellised plants 10, actuators 120 and braking system 130 according to some embodiments of the invention. In some embodiments, each cultivation system 110 may include a cultivation tube 112 having a plurality of holes 114 for planting trellised plants and an irrigation system 116 for providing irrigation to the trellised plants. Some embodiments of cultivation system 110 are illustrated and discussed in dailies with respect to FIGS. 4A-4F herein below. In some embodiments, tube 112 may have any suitable circumferential geometrical shape, for example, a hollow cylinder, a hollow hexagonal prism and the like. In some embodiments, tube 112 may be closed from at least one side with cap 115 (shown also in FIGS. 3 and 4A).

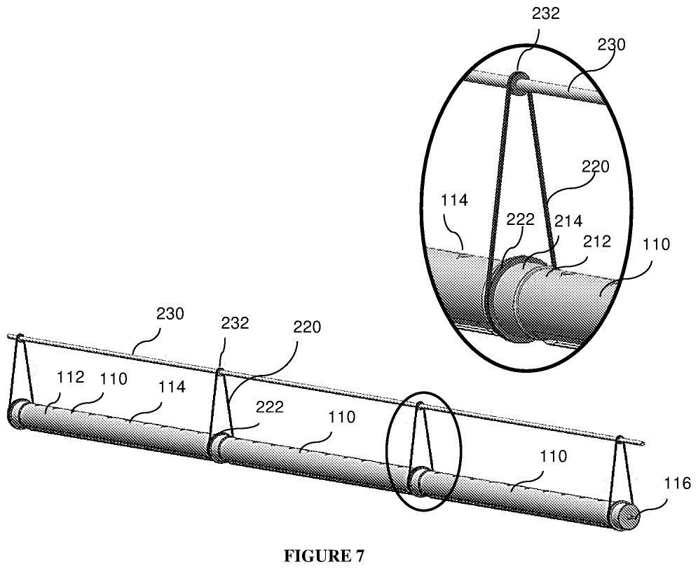

In some embodiments, a plurality of cultivation systems 110 may be connected to each other to create one long cultivation tube. One nonlimiting example for such a connection may include male-female connectors, illustrated and discussed with respect to FIG. 7 herein below. In some embodiments, the connectors connecting two cultivation systems 110 may include an irrigation connecting element (not illustrated) for connecting two irrigation systems 116. Therefore, several cultivation systems 110 may be provided water by a single irrigation pipe.

In some embodiments, at least one actuator 120 may be assembled in system 100 as to deliver a rotational movement to one or more cultivation systems 110. In some embodiments, one actuator 120 may deliver the rotational movement to a plurality of cultivation systems 110. In some embodiments, two or more actuators 120 may deliver the rotational movement to a single cultivation system 120. Actuator 120 is illustrated and discussed in dailies with respect to FIGS. 4A-4F herein below. In some embodiments, the angular movement provided to cultivation systems 110 may cause stems 15 of trellised plants 10 to warp around cultivation tubes 112, as illustrated. In some embodiments, the stems may be warped around cultivation tubes 112 after one or more fruit pickings.

In some embodiments, braking system 130 may prevent rotation of cultivation systems 110, caused by any forces applied to cultivation systems 110. For example, braking system 130 may resist the moment M applied by plants 10 on cultivation tubes 112, according to equation 1:

M=W*g*N*r (1)
Where W is average plant weight of one plant 10; g is gravity constant; N is the number of plants 10 on one tube 112 and r is the radius of tube 112.

In yet another example, braking system 130 may prevent the rotation of tubes 112 due to, for example picking of fruit, cultivation processes and the like.

Reference is now made to FIG. 3 which is an illustration of one cultivation system 110 coupled with actuator 120. In some embodiments, system 100 may include one or more elements 160 connectable to construction 60 of the greenhouse or to a standalone construction 60 located inside the greenhouse. Elements 160 may include hangers and bearings, as illustrated, or may be any other suitable elements.

Reference is now made to FIGS. 4A-4F which are illustrations of various details of system 100 according to some embodiments of the invention. FIG. 4A shows irrigation system 116 in a shape of a pipe (e.g., a hose) that may allow to connect the irrigation systems of two or more cultivation systems 110 by rotatable connectors (not illustrated). Therefore, rotation of cultivation systems 110 may be executed during irrigation. In this nonlimiting example, the pipe may be located at the rotation axis of each cultivation systems 110. In some embodiments, irrigation system 116 may include drip irrigation hose located inside tube 112 (as illustrated in FIG. 4C) or outside from tube 112 (as illustrated in FIG. 4D).

In some embodiment, actuator 120 may include any component, device or mechanism that may deliver a rotational movement, for example, actuator 120 may be a gear activated by a power drive system 122, illustrated in FIGS. 4B and 4C. Power drive system 122 may be, for example, an electric motor, a hydraulic motor, a pneumatic motor and the like. In a nonlimiting example, actuator 120 may include a ratchet 124, illustrated in FIGS. 4A-4B. Another nonlimiting example for an actuator may include angularly driving belts and a rotational shaft illustrated and discussed in FIGS. 5-7.

In some embodiments, braking system 130, illustrated in FIGS. 4A and 4B may include any device, component or system that may prevent cultivation tube 112 from rotating. Braking system 130 may include an external brake configured to lock cultivation tube 112, for example, the ratchet mechanism illustrated. Alternatively, braking system 130 may be included in actuator 120, or power drive system 122, for example, a brake included in an electric motor.

In some embodiments, each cultivation system 110 may be configured to contain a growth substrate 50 located inside cultivation tube 112, as illustrated in FIGS. 4C and 4E. Growth substrate 50 may include any media suitable for growing trellised plants 10 (e.g., Perlite, Coconut fiber, Tuff and the like).

In some embodiments, each cultivation systems 110 may include fertilizing system 118, illustrated in FIG. 4C. In some embodiments, fertilizing system 118 may be an additional stand-alone system assembled in cultivation systems 110. Alternatively, fertilizing system 118 may be included in irrigation system 116.

In some embodiments, each cultivation systems 110 may include a gutter 119 for collecting excess water, as illustrated in FIGS. 4E and 4F. As should be understood by one skilled in the art, illustrated gutter 119 is given as an example only and the invention is not limited to this particular design.

Reference in now made to FIG. 5 which is an illustration of a system 200 for growing trellised plants according to some embodiments of the invention. System 200 may include one or more cultivation systems 110, a plurality of angularly driving belts 220, for supporting and driving one or more cultivation systems 110 and a rotatable shaft 230 configured to carry and rotate one or more cultivation systems 110 hanging from rotatable shaft 230 by driving belts 220. In some embodiments, one or more cultivation systems 110 of system 200 may be substantially the same and may include at least some of the elements, components, systems and devices of one or more cultivation systems 110 of system 100 disclosed hereinabove.

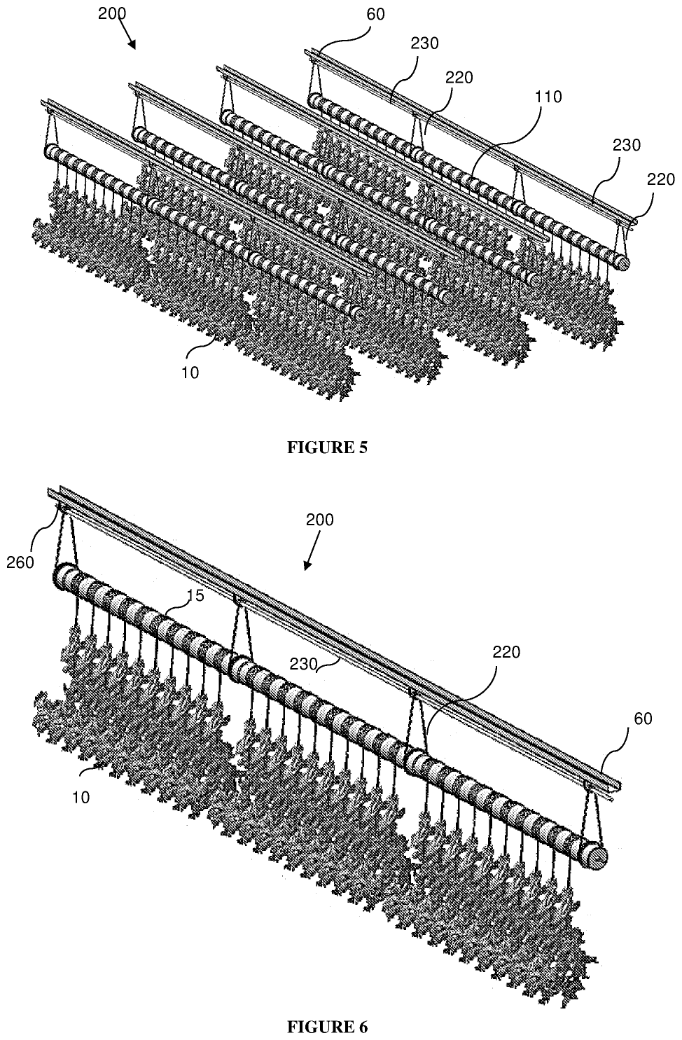

Reference is now made to FIG. 6 which is system 200 planted with trellised plants 10 according to some embodiments of the invention. In some embodiments, rotatable shaft 230 may be configured to be connected to construction 60 of a greenhouse or to standalone construction 60 located in the greenhouse. For example, connectors 260 may connect rotatable shaft 230 to construction 60 in a freely rotating manner, as to allow rotatable shaft 230 to freely rotate around the shaft's longitudinal axis.

Reference is now made to FIG. 7 which is a detailed illustration of system 200 according to some embodiments of the invention. In some embodiments, angularly driving belts 220 may be any driving belts known in the art, for example, driving chains, solid belts and the like, that is configured to transmit angular movement (e.g., rotation) from rotatable shaft 230 to tubes 112 of cultivation systems 110. In some embodiments, each tube 112 may be driven by at least one belt, (as illustrated) or more. In some embodiment, tubes 112 may include driven wheels 222 each may be configured to be driven by a single belt 220.

In some embodiments, a plurality of cultivation systems 110 may be connected to each other to create one long cultivation tube, using for example, male-female connectors included in tubes 112, illustrated as elements 212, 214 in the enlarged detail in FIG. 7. Alternatively, tubes 112 may be connected using any known method and means, for example, by screws connector or welding for connecting one end of a tube 112 to the other end of the next tube 112.

In some embodiments, rotatable shaft 230 may be powered by a power drive system, such as power drive system 122. In some embodiments, one or more power drive system, may be required to rotate a single rotatable shaft 230 for rotating a plurality of cultivation systems 110. In some embodiments, rotatable shaft 230 may include pinions 232 for securing belts 220 and delivering the angular rotation from rotatable shaft 230 to belts 220.

In some embodiments, system 200 may further include a braking system (not illustrated), for example, braking system 130 included in system 100 and discussed herein above.

In some embodiments, system 100 and/or system 200 may further include a controller (not illustrated) configured to control at least one of: actuator 120, power drive system 122, braking system 130, rotatable shaft 230, irrigation system 116 and fertilizing system 118. The controller may be any computing device (e.g., a chip) configured to execute instructions and codes stored on a memory associated with or included in the controller. Such instructions may include instructions for controlling at least one of: actuator 120, power drive system 122, braking system 130, rotatable shaft 230 irrigation system 116 and fertilizing system 118.

In some embodiments, system 100 and/or system 200 may further include or may be in communication with one or more detectors (e.g., sensors, not illustrated) for providing information regarding, the greenhouse, ambient conditions, growth substrate and the like. For example, the sensors may be selected from: a temperature sensor, humidity sensor, a barometer, irrigation sensor, flowmeter, weights and the like. In some embodiments, the instructions stored in the memory associated with the controller may include controlling at least one of: actuator 120, power drive system 122, braking system 130, rotatable shaft 230, irrigation system 116 and fertilizing system 118 based on signals received from at least one sensor.

Reference is now made to FIG. 8 which is a schematic illustration of a leaves removal device 300 for removing leaves of the stems while the plants are being lifted as the cultivation tube is being rotated. Leaves removal device 300 may have a central hole 310 through which plant stem 15 passes and by wires or plates leaves 25 are caught and ripped off the plant.

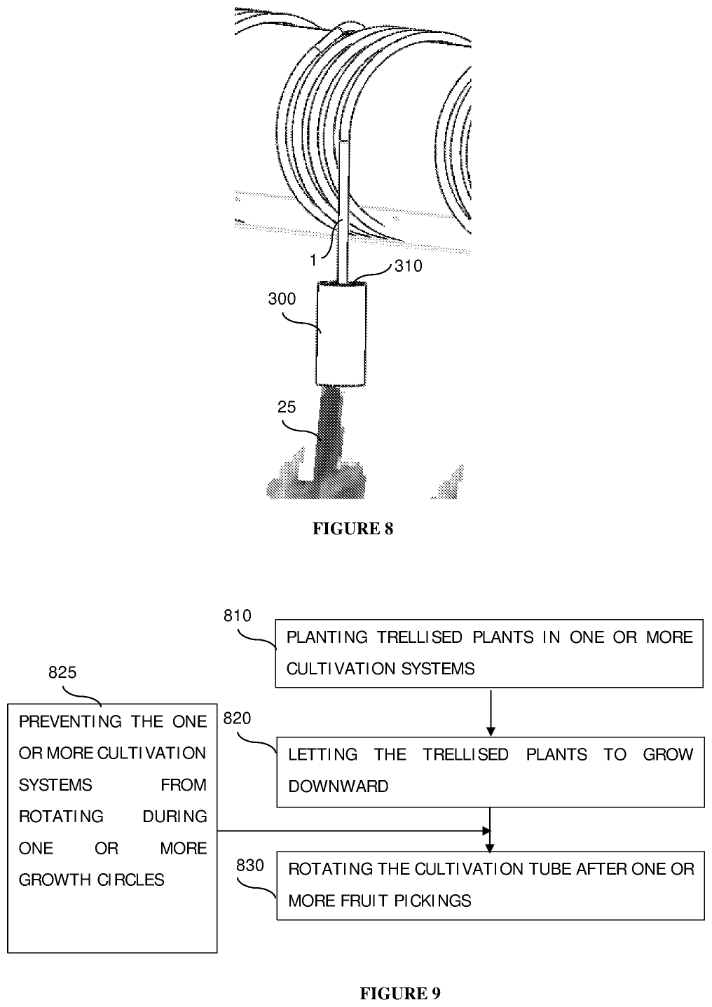

Reference is now made to FIG. 9 which is a flowchart of a method of growing trellised plants according to some embodiments of the invention. In step 810, trellised plants may be planted in one or more cultivation systems. For example, trellised plants 10, such as, tomatoes, cucumbers, etc. may be plated in holes 11 of one or more cultivation systems 110. In such case one or more cultivation systems 110 may be filled with growth substrate 50. In some embodiments, one or more cultivation systems 110 may be included in system 200 and may be hanged from rotatable shaft 230 by a plurality of angularly driving belts 220. In some embodiments, one or more cultivation systems 110 may be included in system 100 and may be connected to an actuator 120.

In step 820, trellised plants 10 may be let grow downwards from at least one cultivation tube 112, as illustrated in FIGS. 1, 2, 5 and 6. In some embodiments, during one or more growth cycles one or more cultivation systems 110 may be prevented from rotating, using for example, braking system 130, in step 825.

In step 830, one or more cultivation systems 110 may be rotated after one or more fruit pickings. For example, one or more cultivation systems 110 may be rotated by actuator 120. In another example, one or more cultivation systems 110 may be rotated by driving belts 220 and rotating shaft 230. Rotating the cultivation systems include wrapping naked plants stems (e.g., stems 15) around cultivation tubes 112. In some embodiments, rotating the cultivation systems may include leaves removal device (e.g., device 300) to remove the leaves from the stems.

1. A system for growing trellised plants, comprising:
one or more cultivation systems;
a plurality of angularly driving belts, for supporting and driving the one or more cultivation systems; and
a rotatable shaft configured to rotate and carry the one or more cultivation systems hanging from the rotatable shaft by the driving belts;
wherein each cultivation system comprises:
a cultivation tube having a plurality of holes for planting the trellised plants; and
an irrigation system for providing irrigation to the trellised plants.

2. The system of claim 1, wherein the rotatable shaft is configured to be connected to a construction of a greenhouse.

3. The system of claim 1, wherein each cultivation system further comprises a fertilizing system.

4. The system of claim 1, wherein each cultivation tube is configured to contain a growth substrate.

5. The system of claim 1, further comprising a power drive system configured to rotate the rotatable shaft.

6. The system of claim 5, further comprising a controller configured to control the power drive system.

7. The system of claim 6, wherein the controller is further configured to control the irrigation system.

8. The system of claim 3, further comprising a controller configured to control the fertilizing system.

9. The system of claim 5, further comprising one or more sensors and wherein the controller is further configured to control at least one of: the power drive system, the irrigation system and the fertilizing system according to signals received from the one or more sensors.

10. The system of claim 1, further comprising a braking system configured to prevent the cultivation tubes from rotating.

11. The system of claim 1, further comprising a gutter for collecting excess water.

12. A method of growing trellised plants, comprising:
planting trellised plants in one or more cultivation systems, hanged from a rotatable shaft by a plurality of upper driving belts, wherein each cultivation system comprises:
a cultivation tube having a plurality of holes for planting the trellised plants; and
an irrigation system for providing irrigation to the trellised plants;
letting the trellised plants to grow downwards from at least one cultivation tube; and
rotating the rotatable shaft to rotate the cultivation tube after one or more fruit pickings.

13. The method of claim 12, wherein rotating the rotatable shaft comprises:
wrapping naked plants stems around the cultivation tubes.

14. The method of claim 13, wherein rotating the rotatable shaft further comprises:
removing leaves from the stems.

15. A system for growing trellised plants, comprising:
one or more cultivation systems,
wherein each cultivation system comprises:
a cultivation tube having a plurality of holes for planting the trellised plants; and
an irrigation system for providing irrigation to the trellised plants;
one or more actuators configured to deliver a rotational movement to the one or more cultivation systems; and
a braking system configured to prevent the cultivation tubes from rotating.

16. The system of claim 15, further comprising a power drive system configured to rotate the one or more cultivation systems.

17. The system of claim 15, further comprising one or more elements connectable to a construction of a greenhouse.

18. The system of claim 15, wherein each cultivation system further comprises a fertilizing system.

19. The system of claim 15, wherein each cultivation is configured to contain a growth substrate.

20. The system of claim 15, further comprising a controller configured to control the one or more power drive systems.

21.-27. (canceled)
